(19) United States
(12) Patent Application Publication
(10) Pub. No.: US 2015/0330128 A1
(43) Pub. Date: Nov. 19, 2015

(54) HINGE WITH LARGE OPEN-CLOSE ANGLE FOR FUNITURE DOOR

(71) Applicant: GUANGDONG TAIMING METAL PRODUCTS CO. LTD, Foshan City (CN)

(72) Inventor: Tai Wai NG, Foshan City (CN)

(73) Assignee: GUANGDONG TAIMING METAL PRODUCTS CO. LTD, Foshan City (CN)

(21) Appl. No.: 14/708,704

(22) Filed: May 11, 2015

(30) Foreign Application Priority Data
May 13, 2014 (CN) 201420244781.4

(51) Int. Cl. E05D 3/16; E05F 3/20

(52) U.S. Cl. CPC E05D 3/16; E05F 3/20

(57) ABSTRACT

A hinge with large open-close angle for furniture door includes a retaining bracket connected to wallboard, a sliding seat connected to the door and a hinge module connected with the retaining bracket and the sliding seat. The hinge module includes a fixed arm, a link arm, the first turning arm, the second turning arm and the third turning arm hinged successively. Whereby, one end of the first turning arm with salient point or bend is hinged with the retaining bracket. The said retaining bracket is installed with damper and rocking block. The damper has reset spring, while the rocking block has the first and the second acting surface. In the process of hinge closing, the first acting surface aims to coordinate with the salient point or bend on the first turning arm, while the second acting surface is coordinated with the damper.

### FIELD OF THE INVENTION

This utility model involves a kind of hinge with large open-close angle for furniture door.

### BACKGROUND OF THE INVENTION

On Jan. 9, 2009, it is published in Chinese patent document numbered CN201339380 a hinge which includes door box, connecting rod, hinge arm, shifting arm, base, buffer, torsional spring, connector and lever driver. The connector is in fan-shaped structure, with a center hole and three circumference holes. With the center hole, the connector is movably connected to the hinge arm. One of the three circumference holes is movably connected to the terminal of piston rod of the buffer. The rest circumference holes have axle, and the lever driver has end hole, middle hole and two fork holes on the other side opposite to the end hole. With the middle hole, the lever driver is movably connected to the hinge arm, leaving the two fork holes mesh the two axles of the two circumference holes. The other side of the lever driver is movably connected to the door box through the end hole. The torsional spring, installed on the connecting rod compresses the hinge arm, the connecting rod and the door box to generate the opening or closing of the hinge arm. Purportedly, this structure is simple, reliable and flexible. However, great effort is required to open or close the door because of the resistance of the buffer, easily resulting in the damage of the doorknob or the uncompleted closing of the door. Besides, open-close angle of the hinge can't be adjusted in the course of using, leading to inconvenience to use and failure to meet customers' needs, therefore, further improvement is needed.

### SUMMARY OF THE INVENTION

This utility model aims to provide a hinge with large open-close angle for furniture door. The hinge is characterized by simple and reasonable structure, low production cost, dependable performance, convenient adjustment, in addition, each component can be connected compactly and opened or closed freely. Moreover, it can be opened and closed at any angle in any time with low noise. This hinge aims to overcome the disadvantages of the existing technology.

According to this purpose, this hinge with large open-close angle for furniture door includes a retaining bracket connected to wallboard, a sliding seat connected to door and a hinge module connected with the retaining bracket and the sliding seat. This hinge is characterized by the feature that the hinge module includes a fixed arm, a link arm, the first turning arm, the second turning arm and the third turning arm hinged successively. Whereby, one end of the first turning arm with salient point or bend is hinged with the sliding seat. The said sliding seat is installed with damper and rocking block. The damper has a reset spring, while the rocking block has the first acting surface and the second acting surface. In the process of hinge closing, the first acting surface aims to coordinate with the salient point or bend on the first turning arm, while the second acting surface is coordinated with the damper.

The said rocking block has integral or segregated junction. With the junction, the rocking block is installed on the sliding seat. The rocking block has the first acting surface and the second acting surface. In the process of hinge closing, the first acting surface aims to coordinate with the salient point or bend on the first turning arm, while the second acting surface is coordinated with the damper.

The said first acting surface and the second acting surface are comprised of more than one curved surface, plane or the combination of curved surface and plane. Therefore, its surface is open, U-shape or ring-grooved.

One end of the said damper is installed on the sliding seat, while the inclined plane on other end aims to coordinate with the second acting surface of the rocking block.

A regulating mechanism is installed on the said first turning arm. The regulating mechanism includes eccentric adjuster and sliding adjuster. At least by the coordination of these tow adjusters, the turning arm can adjust the open-close angel of the hinge.

The said eccentric adjuster is eccentric cam or eccentric disc, installed between the first turning arm and the fixed arm. The sliding adjuster has adjusting acting part, corresponding to eccentric cam or eccentric disc.

The cross section of the said three turning arms is in the shape of U-steel. Each end of the first turning arm is hinged with one end of link arm and one end of the sliding seat respectively, while the middle part of the first turning arm is hinged with the middle part of the second turning arm. The other end of the link arm is hinged with one end of the fixed arm. And each end of the second turning arm is hinged with the other end of the fixed arm and one end of the third turning arm. The other end of the third turning arm is hinged with the other end of the sliding seat.

There is a spring seat on the second turning arm, and a pressure spring on the spring seat. One end of the spring seat is installed on the hinge place of the first turning arm and the second turning arm, while the other end of the spring seat has colloidal particle. There is hook object on the hinge place of the second turning arm and the third turning arm. One end of the hook with arc surface object is against the colloidal particle.

There is snap-gauge on the fixed arm which can be connected with the retaining bracket through the snap-gauge.

By installing a buffer, a rocking block on the sliding seat, a reset spring on the buffer, two acting surface on the rocking block, the coordination between the first acting surface and the salient point or bend on the first turning arm and the coordination between the second acting surface and the damper, the disadvantage that buffer just can be installed on the fixed arm in the existing technology is solved effectively. It not only simplifies the hinge structure and the production process but also reduces the production cost. In the process of hinge closing, by the respective connection between the first and the second acting surface with the first turning arm and the buffer, the aim to control the speed and potency dimension of the hinge closing is realized. With smaller collision and lower noise, the zero noise and speed-controllable closing are truly realized. Moreover, a regulating mechanism with eccentric adjuster and sliding adjuster is installed on the first turning arm. At least by the coordination of these two adjusters, the turning arm can adjust the open-close angle of the hinge. Customers can adjust the open-close angle of the hinge according to their specific needs. It means that this hinge is more human-based and in line with modern people's needs. This hinge is characterized by simple and reasonable structure, low production cost, dependable performance and convenient adjustment, in addition, each component can be connected compactly, and can be opened or closed freely. Moreover, it is very practical because it can control the open-close angle of the hinge in any time under low noise.

### DESCRIPTION OF DIAGRAMS

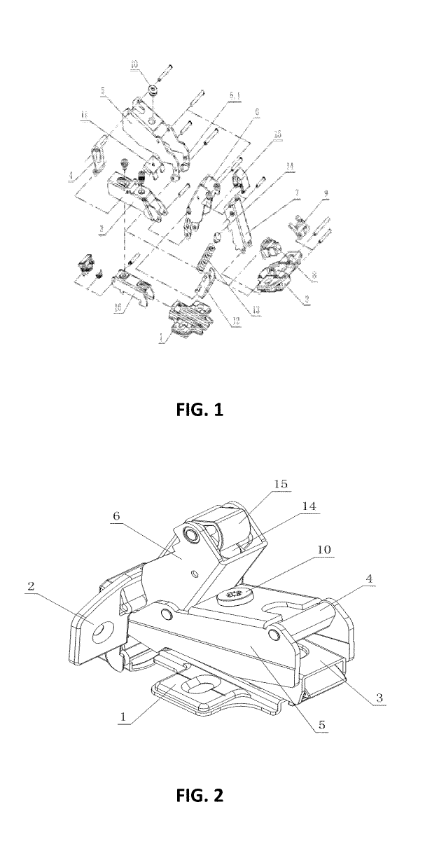

FIG. 1 is the breakdown structure of this utility model.

FIG. 2 is the structure diagram of this utility model.

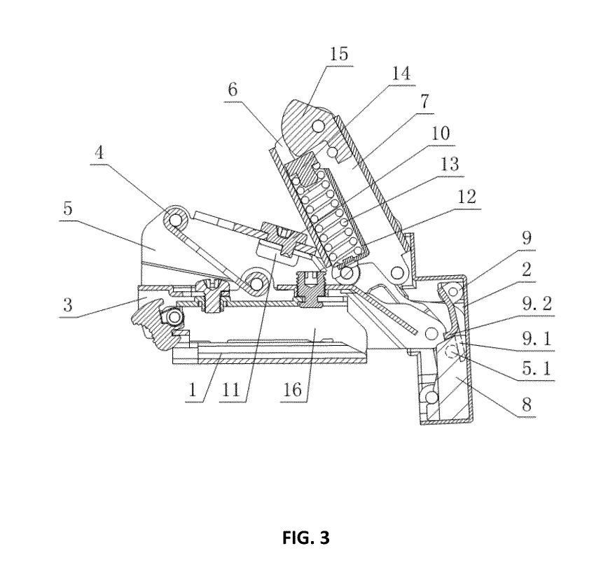

FIG. 3 is the structure diagram under the off position of this utility model (section view).

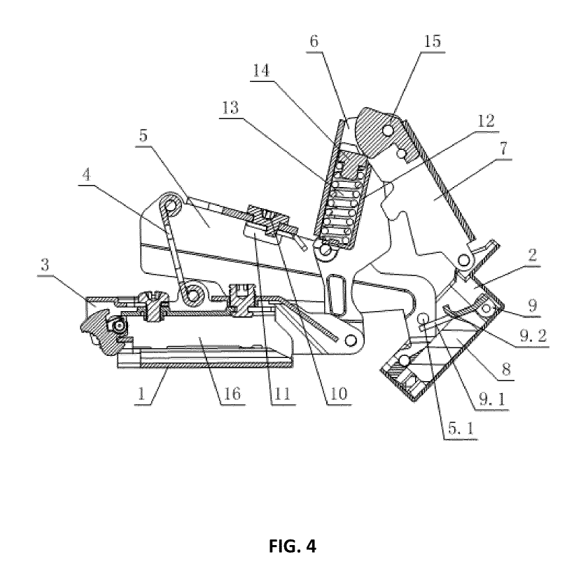

FIG. 4 is the structure diagram under the on position of this utility model (section view).

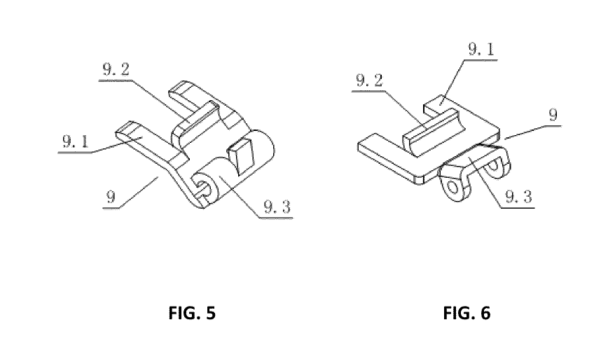

FIG. 5 and FIG. 6 are the structure diagrams of rocking block under multiple application cases.

### SPECIFIC EMBODIMENT METHOD

Hereinafter, figures and application cases are combined to describe this utility model.

FIG. 1 to FIG. 5 for a hinge with large open-close angle for furniture door which includes a retaining bracket (1) connected to wallboard, a sliding seat (2) connected to the door and a hinge module connected with the retaining bracket (1) and the sliding seat (2). It is characterized by the feature that the hinge module includes a fixed arm (3), a link arm (4), the first turning arm (5), the second turning arm (6) and the third turning arm (7) hinged successively. Whereby, one end of the first turning arm (5) with salient point (5.1) or bend is hinged with the sliding seat (2). The said sliding seat (2) is installed with damper (8) and rocking block (9). The damper (8) has reset spring, while the rocking block (9) has the first acting surface (9.1) and the second acting surface (9.2). In the process of hinge closing, the first acting surface (9.1) aims to coordinate with the salient point (5.1) or bend on the first turning arm (5), while the second acting surface (9.2) is coordinated with the damper (8).

One end of the rocking block (9) has integral or segregated junction (9.3). See FIG. 5 for details that the integrated bending junction (9.3) on one end of the rocking block (9) is movably installed on the sliding seat (2). Or see FIG. 6 for details that the segregated welding junction (9.3) on one end of the rocking block (9) is movably installed on the sliding seat (2). The rocking block (9) has the first acting surface (9.1) and the second acting surface (9.2). In the process of hinge closing, the first acting surface (9.1) aims to coordinate with the salient point (5.1) or bend on the first turning arm (5), while the second acting surface (9.2) is coordinated with the damper (8). The first acting surface (9.1) and the second acting surface (9.2) are comprised of more than one curved surface, plane or the combination of curved surface and plane. Therefore, its surface is open, U-shape or ring-grooved. The said damper (8) is installed on the sliding seat (2), while the inclined plane on other end aims to coordinate with the second acting surface (9.2) of the rocking block (9).

In the structure above, a regulating mechanism is installed on the said first turning arm (5). The regulating mechanism includes eccentric adjuster (10) and sliding adjuster (11). At least by the coordination of these tow piece, the turning arm (5) can adjust the open-close angle of the hinge. The eccentric adjuster (10) is eccentric cam or eccentric disc, installed between the first turning arm (5) and the fixed arm (3). The sliding adjuster (11) has adjusting acting part, corresponding to eccentric cam or eccentric disc.

The first turning arm (5), the second turning arm (6) and the third turning arm (7) is in the shape of U-steel. And each end of the first turning arm (5) is hinged with one end of link arm (4) and one end of the sliding seat (2) respectively, while the middle part of the first turning arm (5) is hinged with the middle part of the second turning arm (6). The other end of the link arm (4) is hinged with one end of the fixed arm (3). And each end of the second turning arm (6) is hinged with the other end of the fixed arm (3) and one end of the third turning arm (7). The other end of the third turning arm (7) is hinged with the other end of the sliding seat (2). There is a spring seat (12) on the second turning arm (6), and a pressure spring (13) on the spring seat (12). One end of the spring seat (12) is installed on the hinge place of the first turning arm (5) and the second turning arm (6), while the other end of the spring seat (12) has colloidal particle (14). There is hook object (15) on the hinge place of the second turning arm (6) and the second turning arm (7). With arc surface, one end of the hook object (15) is against the colloidal particle (14).

There is snap-gauge (16) on the fixed arm (3) which can be connected with the retaining bracket (1) through the snap-gauge (16).

The above is the preferred embodiment of the utility model. Simple variant or modification by ordinary technical personnel in this field is within range of protection of this utility model.

What is claimed:

1. A hinge with large open-close angle for furniture door comprising:
a retaining bracket connected to wallboard, a sliding seat connected to the door and a hinge module connected with the retaining bracket and the sliding seat, the hinge module includes a fixed arm, a link arm, the first turning arm, the second turning arm and the third turning arm hinged successively, wherein, one end of the first turning arm with salient point or bend is hinged with the sliding seat, the sliding seat is installed with damper and rocking block, the damper has reset spring, while the rocking block has the first acting surface and the second acting surface, wherein in the process of hinge closing, the first acting surface aims to coordinate with the salient point or bend on the first turning arm, while the second acting surface is coordinated with the damper.

2. The hinge with large open-close angle for furniture door of claim 1, wherein the said rocking block has integrated or segregated junction, with the junction, the rocking block is installed on the sliding seat, the rocking block has the first acting surface and the second acting surface, wherein in the process of hinge closing, the first acting surface aims to coordinate with the salient point or bend on the first turning arm, while the second acting surface is coordinated with the damper.

3. The hinge with large open-close angle for furniture door of claim 2, wherein the first acting surface and the second acting surface are comprised of more than one curved surface, plane or the combination of curved surface and plane, wherein the surface is open, U-shape or ring grooved.

4. The hinge with large open-close angle for furniture door of claim 3, wherein one end of the said damper is installed on the sliding seat, while the inclined plane on the other end aims to coordinate with the second acting surface of the rocking block in the process of hinge closing.

5. The hinge with large open-close angle for furniture door of claim 1, wherein a regulating mechanism is installed on the said first turning arm, the regulating mechanism includes eccentric adjuster and sliding adjuster, wherein at least by the coordination of these two pieces, the turning arm can adjust the open-close angle of the hinge.

6. The hinge with large open-close angle for furniture door of claim 5, wherein the said eccentric adjuster is eccentric cam or eccentric disc, installed between the first turning arm and the fixed arm, wherein the sliding adjuster has adjusting acting part, corresponding to eccentric cam or eccentric disc.

7. The hinge with large open-close angle for furniture door of claim 6, wherein the cross section of the said first turning arm, the second turning arm and the third turning arm is in the shape of U-steel, wherein each end of the first turning arm is hinged with one end of link arm and one end of the sliding seat respectively, while the middle part of the first turning arm is hinged with the middle part of the second turning arm, wherein the other end of the link arm is hinged with one end of the fixed arm, wherein each end of the second turning arm is hinged with the other end of the fixed arm and one end of the third turning arm, and the other end of the third turning arm is hinged with the other end of the sliding seat.

8. The hinge with large open-close angle for furniture door of claim 7, wherein there is a spring seat on the second turning arm, and a pressure spring on the spring seat, wherein one end of the spring seat is installed on the hinge place of the first turning arm and the second turning arm, while the other end of the spring seat has colloidal particle; a hook object on the hinge place of the second turning arm and the second turning arm; and arc surface, wherein one end of the hook object is against the colloidal particle.

9. The hinge with large open-close angle for furniture door of claim 8, wherein there is snap-gauge on the said fixed arm which can be connected with the retaining bracket through the snap-gauge.
